(19) United States
(12) Patent Application Publication
(10) Pub. No.: US 2010/0249279 A1
(43) Pub. Date: Sep. 30, 2010

(54) THERMALLY CURABLE RESIN COMPOSITION AND CURED PRODUCT THEREOF

(75) Inventors: Yuta OGAWA, Saitama (JP); Shinichiro Fukuda, Saitama (JP); Katsuto Murata, Saitama (JP)

Correspondence Address: Ditthavong Mori & Steiner, P.C., 918 Prince Street, Alexandria, VA, 22314, US

(73) Assignee: TAIYO INK MFG. CO., LTD.,, Tokyo (JP)

(21) Appl. No.: 12/727,255

(22) Filed: Mar. 19, 2010

(30) Foreign Application Priority Data
Mar. 31, 2009 (JP) 2009-086086

(51) Int. Cl. C08K 3/36

(52) U.S. Cl. 523/443; 523/466; 524/609; 524/493

(57) ABSTRACT

A thermally curable resin composition includes a linear thermally curable resin and amorphous silica fine particles having pore portions.

### CROSS-REFERENCE TO RELATED APPLICATIONS

The present application claims priority under 35 U.S.C.§119 to Japanese Patent Application No. 2009-086086, filed Mar. 31, 2009. The contents of this application are incorporated herein by reference in their entirety.

### BACKGROUND OF THE INVENTION

1. Field of the Invention

The present invention relates to a thermally curable resin composition and a cured product thereof.

2. Discussion of the Background

With the increased density and improved performance of semiconductor package substrates, the clearance of flip chip bumps which connect semiconductor chips to circuit boards is increasingly narrowed. However, there are problems that cracks occur in the substrate due to stresses caused by a difference in the amount of expansion by a change in temperature between these different materials, and the like. It is thus required to reduce the coefficient of linear expansion (referred to as “the coefficient of thermal expansion” in some cases) of a thermally curable resin composition to a value close to the coefficients of linear expansion of other materials used in the circuit board. On the other hand, for lessening an inevitable difference in the amount of expansion, the thermally curable resin composition is required to have a coating property called extensibility which is contradictory to reduction of the coefficient of linear expansion. Furthermore, it is desirable that the thermally curable resin composition should have the improved mechanical strength of a cured coating for preventing ruptures resulting from various mechanical and thermal impacts which are encountered during processes of manufacture to mounting of the semiconductor package substrate.

As a method for reduction of the coefficient of linear expansion, there is a method of filling the curable resin composition with spherical silica (Japanese Unexamined Patent Publication No. 2001-49220). Furthermore, there is a method in which by using porous silica, the coefficient of linear expansion is further reduced with a filled amount same as that of other inorganic fillers (Japanese Unexamined Patent Publication No. 2008-150578).

### SUMMARY OF THE INVENTION

According to one aspect of the present invention, a thermally curable resin composition includes a linear thermally curable resin and amorphous silica fine particles having pore portions.

According to another aspect of the present invention, a cured product is of a thermally curable resin composition. The thermally curable resin composition includes a linear thermally curable resin and amorphous silica fine particles having pore portions. The amorphous silica fine particles cure to be a cured resin. The cured resin communicates with the pore portions of the amorphous silica fine particles.

According to still another aspect of the present invention, a cured product is of a thermally curable resin composition. The thermally curable resin composition includes a linear thermally curable resin composition and amorphous silica fine particles having a honeycomb structure.

### DESCRIPTION OF THE EMBODIMENTS

The thermally curable resin composition of an embodiment of the present invention will be described below.

The thermally curable resin composition of the embodiment of the present invention includes a linear thermally curable resin and amorphous silica fine particles (hereinafter referred to as “silica fine particles” in some cases) having through-pores. Preferably, the linear thermally curable resin communicates with through-pores of amorphous silica fine particles.

The state of communication herein may be a state in which the linear thermally curable resin is completely filled in through-pores of amorphous silica fine particles, or may be a state in which the interior of the through-pore is partly void as long as the linear thermally curable resin which has entered the through-pore at both ends of the through-pore is contiguous.

The linear thermally curable resin is a thermally curable resin having a linear structure in terms of effective communication with the interior of the air gap of amorphous silica fine particles having through-pores. Such linear thermally curable resins are not particularly limited as long as the thermally curable resin itself, and the thermally curable resin and a curing agent for the thermally curable resin undergo a curing reaction under heating. Preferable are compounds having two or more epoxy groups per molecule, namely multifunctional epoxy compounds, or compounds having two or more thioether groups per molecule, namely episulfide resins and the like. Among them, epoxy resins having a linear structure include, for example, bisphenol A epoxy resins such as jER 828, jER 834, jER 1001 and jER 1004 manufactured by Japan Epoxy Resins Co., Ltd., Epiclon 840, Epiclon 850, Epiclon 1050 and Epiclon 2055 manufactured by DIC Corporation, Epotoht YD-011, YD-013, YD-127 and YD-128 manufactured by Tohto Kasei Co., Ltd., D.E.R. 317, D.E.R. 331, D.E.R. 661 and D.E.R. 664 manufactured by The Dow Chemical Company, Araldite 6071, Araldite 6084, Araldite GY 250 and Araldite GY 260 manufactured by Huntsman Advanced Materials Inc., Sumi-Epoxy ESA-011, ESA-014, ELA-115 and ELA-128 manufactured by Sumitomo Chemical Co., Ltd., and A.E.R. 330, A.E.R. 331, A.E.R. 661 and A.E.R. 664 manufactured by Asahi Chemical Industry Co., Ltd. (they are all trade names); bisphenol F epoxy resins such as jER 807 manufactured by Japan Epoxy Resins Co., Ltd., Epotoht YDF-170, YDF-175 and YDF-2004 manufactured by Tohto Kasei Co., Ltd., and Araldite XPY 306 manufactured by Huntsman Advanced Materials Inc. (they are all trade names); bisphenol S epoxy resins such as EBPS-200 manufactured by NIPPON KAYAKU Co., Ltd., EPX-30 manufactured by Asahi Denka Kogyo K.K., and EXA-1514 manufactured by DIC Corporation (they are all trade names); hydrogenated bisphenol A epoxy resins such as Epotoht ST-2004, ST-2007 and ST-3000 manufactured by Tohto Kasei Co., Ltd. (they are all trade names); bixylenol or biphenol epoxy resins or mixtures thereof such as YL-6056, YX-4000 and YL-6121 manufactured by Japan Epoxy Resins Co., Ltd. (they are all trade names); and phenol aralkyl epoxy resins such as NC-3000 (trade name) manufactured by NIPPON KAYAKU Co., Ltd., and episulfide resins having a linear structure include, for example, bisphenol A episulfide resin YL-7000 (trade name) manufactured by Japan Epoxy Resins Co., Ltd. Using a similar synthesis method, episulfide resins in which oxygen atoms of the epoxy group of the abovementioned epoxy resin having a linear structure are replaced by sulfur atoms, and the like, may also be used. In the embodiment of the present invention, one type of linear thermally curable resin may be used, or two or more types of linear thermally curable resins may be used.

In the thermally curable resin composition of the embodiment of the present invention, the abovementioned linear thermally curable resins may be used in conjunction with other thermally curable resins to the extent that the effect of the embodiment of the present invention is exhibited.

The aforementioned other thermally curable resins are not particularly limited as long as the thermally curable resin itself, and the thermally curable resin and a curing agent for the thermally curable resin undergo a curing reaction under heating. Preferable are compounds having three or more epoxy groups per molecule, namely multifunctional epoxy compounds, or compounds having three or more thioether groups per molecule, namely episulfide resins and the like. Preferably, tri- or more functional nonlinear epoxy resins may be used as the aforementioned other thermally curable resins.

For example, the aforementioned multifunctional epoxy compounds include, but are not limited to, brominated epoxy resins jERYL 903 manufactured by Japan Epoxy Resins Co., Ltd., Epiclon 152 and Epiclon 165 manufactured by DIC Corporation, Epotoht YDB-400 and YDB-500 manufactured by Tohto Kasei Co., Ltd., D.E.R. 542 manufactured by The Dow Chemical Company, Araldite 8011 manufactured by Huntsman Advanced Materials Inc., Sumi-Epoxy ESB-400 and ESB-700 manufactured by Sumitomo Chemical Co., Ltd., and A.E.R. 711 and A.E.R. 714 manufactured by Asahi Chemical Industry Co., Ltd. (they are all trade names); novolac epoxy resins such as jER 152 and jER 154 manufactured by Japan Epoxy Resins Co., Ltd., D.E.N. 431 and D.E.N. 438 manufactured by The Dow Chemical Company, Epiclon N-730, Epiclon N-770 and Epiclon N-865 manufactured by DIC Corporation, Epotoht YDCN-701 and YDCN-704 manufactured by Tohto Kasei Co., Ltd., Araldite ECN 1235, Araldite ECN 1237, Araldite ECN 1299 and Araldite XPY 307 manufactured by Huntsman Advanced Materials Inc., EPPN-201, EOCN-1025, EOCN-1020, EOCN-1045 and RE-306 manufactured by NIPPON KAYAKU Co., Ltd., Sumi-Epoxy ESCN-195X and ESCN-220 manufactured by Sumitomo Chemical Co., Ltd., and A.E.R. ECN-235 and ECN-299 manufactured by Asahi Chemical Industry Co., Ltd. (they are all trade names); glycidyl amine epoxy resins such as Epiclon 830 manufactured by DIC Corporation, iER 604 manufactured by Japan Epoxy Resins Co., Ltd., Epotoht YH-434 manufactured by Tohto Kasei Co., Ltd., Araldite MY 720 manufactured by Huntsman Advanced Materials Inc., Sumi-Epoxy ELM-120 manufactured by Sumitomo Chemical Co., Ltd. (they are all trade names); hydantoin epoxy resins such as Araldite CY-350 (trade name) manufactured by Huntsman Advanced Materials Inc.; alicyclic epoxy resins such as Seroxide 2021 manufactured by Daicel Chemical Industries, Ltd., and Araldite CY 175 and CY 179 of Huntsman Advanced Materials Inc. (they are all trade names); trihydroxy phenyl methane epoxy resins such as YL-933 manufactured by Japan Epoxy Resins Co., Ltd., and T.E.N., EPPN-5-1 and EPPN-502 manufactured by The Dow Chemical Company (they are all trade names); bisphenol A novolac epoxy resins such as jER 157S (trade name) manufactured by Japan Epoxy Resins Co., Ltd.; tetraphenylol ethane epoxy resins such as iERYL-931 manufactured by Japan Epoxy Resins Co., Ltd. And Araldite 163 of Huntsman Advanced Materials Inc. (they are all trade names); heterocyclic epoxy resins such as Araldite PT 810 manufactured by Huntsman Advanced Materials Inc. and TEPIC manufactured by Nissan Chemical Industries, Ltd. (they are all trade names); diglycidyl phthalate resins such as Blemmer DGT manufactured by NOF Corporation; tetraglycidyl xylenol ethane resins such as ZX-1063 (trade name) manufactured by Tohto Kasei Co., Ltd.; naphthalene group-containing epoxy resins such as ESN-190 and ESN-360 manufactured by Nippon Steel Chemical Co., Ltd. and HP-4032, EXA-4750 and EXA-4700 manufactured by DIC Corporation (they are all trade names); epoxy resins having an anthracene backbone such as YX-8800 (trade name) manufactured by Japan Epoxy Resins Co., Ltd.; epoxy resins having zicyclopentadiene backbone such as HP-7200 and HP-7200H manufactured by DIC Corporation (they are all trade names); glycidyl methacrylate copolymer based epoxy resins such as CP-50S and CP-50M manufactured by NOF Corporation (they are all trade names); and further cyclohexylmaleimide-glycidyl methacrylate copolymer epoxy resins; and epoxy-modified polybutadiene rubber derivatives (for example, PB-3600 (trade name) manufactured by Daicel Chemical Industries, Ltd.), and CTBN-modified epoxy resins (for example, YR-102 and YR-450 manufactured by Tohto Kasei Co., Ltd. (they are all trade names)). These epoxy resins may be used alone or in combination of two or more types. Among them, novolac epoxy resins, heterocyclic epoxy resins, bisphenol A epoxy resins or mixtures thereof are particularly preferable.

Furthermore, as the aforementioned compounds having three or more thioether groups per molecule, episulfide resins in which oxygen atoms of the epoxy group of the aforementioned tri- or more functional multifunctional epoxy resin is replaced by sulfur atoms, and the like, may also be used, using a publicly known conventional synthesis method.

The thermally curable resin composition of the embodiment of the present invention may contain a curing agent for the thermally curable resin as required. The thermally curable resin curing agents are not particularly limited, and may include amines, phenol resins, acid anhydrides, carboxyl group-containing compounds and hydroxyl group-containing compounds.

The thermally curable resin composition of the embodiment of the present invention may contain a thermally curing catalyst as required. Such thermally curing catalysts include, for example, imidazole derivatives such as imidazole, 2-methylimidazole, 2-ethylimidazole, 2-ethyl-4-methylimidazole, 2-phenylimidazole, 4-phenylimidazole, 1-cyanoethyl-2-phenylimidazole, and 1-(2-cyanoethyl)-2-ethyl-4-methylimidazole; amine compounds such as dicyandiamide, benzyldimethylamine, 4-(dimetylamino)-N, N-dimethylbenzylamine, 4-methoxy-N,N-dimethylbenzylamine and 4-methyl-N,N-dimethylbenzylamine, hydrazine compounds such as dihydrazide adipate and dihydrazide sebacate; and phosphor compounds such as triphenylphosphine.

Furthermore, those that are commercially available include, for example, 2MZ-A, 2MZ-OK, 2PHZ, 2P4BHZ and 2P4MHZ manufactured by Shikoku Chemicals Corporation (they are all trade names of imidazole-based compounds), and U-CAT 3503N and U-CAT 3502T (they are all trade names of block isocyanate compounds of dimethylamine) and DBU, DBN, U-CATSA 102 and U-CAT 5002 (they are all bicyclic amidine compounds and salts thereof) manufactured by San-Apro Ltd. The thermally curing catalysts are not particularly limited thereto, and may be any compounds which promote a reaction of the thermally curable resin or a reaction of the thermally curable resin with its curing agent. They may be used alone, or in combination of two or more types. S-triazine derivatives such as guanamine, acetoguanamine, benzoguanamine, melamine, 2,4-diamino-6-methacryloyloxyethyl-S-triazine, 2-vinyl-4,6-diamino-S-triazine, 2-vinyl-4,6-diamino-S-triazine isocyanuric acid adducts and 2, 4-diamino-6-methacryloyloxyethyl-S-triazine isocyanuric acid adducts may also be used as thermally curing catalysts.

Amorphous silica fine particles having through-pores are amorphous silica fine particles having at least one through-pore and generally are amorphous silica fine particles having an average particle size of several nanometers to several tens of micrometers. The sectional form and pore diameter of the through-pore is not particularly limited as long as the linear thermally curable resin can be filled therein, but silica fine particles having a honeycomb structure are preferable, and for example, mesoporous silica having a honeycomb structure may be mentioned. This “honeycomb” structure generally refers to a structure formed by bringing together tubular bodies having through-pores having a polygonal, e.g. hexagonal, cross section. Methods for producing mesoporous silica having a honeycomb structure are not particularly limited, and those produced by a publicly known method may be used. Furthermore, as mesoporous silica having honeycomb structure, those that are commercially available, for example, Admaporous (trade name) manufactured by Admatechs may be used.

The diameter of through-pore and the pore diameter of silica fine particles having a honeycomb structure are not particularly limited, but preferably about 1 nm to about 10 nm. If they are less than 1 nm, it becomes difficult for the linear thermally curable resin to sufficiently communicate with silica fine particles, and the coating strength tends to decrease. Furthermore, the abovementioned pore diameter can be measured by a publicly known adsorption method.

The average particle size of the aforementioned silica fine particles is desirably about 0.01 to about 10 μm, more desirably about 0.01 to about 5 μm. If the silica fine particles are too large, formation of very small wirings may be adversely affected when a circuit board is prepared. If the abovementioned particle size is less than 0.01 μm, the surface area of the silica fine particle becomes so great that it is difficult to increase a filling factor with respect to the amount of thermally curable resin and it is thus difficult to obtain desired properties. The abovementioned average particle size can be measured by a publicly known method, and may be measured using, for example, a laser diffraction/scattering particle size distribution measuring apparatus.

When the abovementioned silica fine particles are incorporated into the thermally curable resin composition, the silica fine particles may be dispersed in a solvent or take a powdered form, but are ideally incorporated in a slurry form having a solvent as a main ingredient in terms of ease with which the thermally curable resin is filled and prevention of generation of crude particles resulting from insufficient dispersion.

One or more publicly known conventional inorganic fillers such as barium sulfate, barium titanate, spherical silica, talc, clay, magnesium carbonate, calcium carbonate, aluminum oxide, aluminum hydroxide, magnesium hydroxide and mica may be further incorporated into the thermally curable resin composition of the embodiment of the present invention in conjunction with the abovementioned silica fine particles as required. They are used for the purpose of improving properties such as the adhesion of the coating, hardness and thermal conductivity. Among them, spherical silica is preferable in terms of insulation reliability.

The thermally curable resin composition of the embodiment of the present invention can be obtained by causing the linear thermally curable resin to communicate with amorphous silica fine particles having through-pores. The communication is considered to be achieved by capillarity which is dependent on the aperture diameter of the through-pore of the aforementioned silica fine particle and adsorption of the resin composition to the silica fine particle surface. Therefore, it is conceivable that components capable of communication with silica fine particles have a size equal to or less than the aperture diameter of the silica fine particles. Thus, as a result vigorous studies, the present inventors have found that it is preferable to incorporate the linear thermally curable resin. Introduction of an organic modifier group having an affinity with the linear thermally curable resin, for example, an alkyl group or epoxy group, into the surfaces and pores of silica fine particles is also useful in terms of using adsorption phenomenon. For communication, there is a method of using a master batch in which amorphous silica fine particles having through-pores are previously mixed with a thermally curable resin to cause the thermally curable resin to communicate with the silica fine particles. Moreover, mention is also made to a method in which during a stage of preparing a resin composition, amorphous silica fine particles in a slurry form having a solvent as a main ingredient are previously prepared and a resin and the like are mixed therewith to obtain a composition, followed by causing the thermally curable resin to communicate with the silica fine particles. In the case of the latter method, it is conceivable that in the composition, the thermally curable resin composition diffuses into the solvent of the silica fine particle slurry and that when the solvent is volatilized in the process of drying or thermally curing the resin composition, the resin composition moves to a location where the solvent has existed.

Amorphous silica fine particles having through-pores may be used generally in an amount of 0.1 to 75 parts by mass, preferably 1 to 60 parts by mass based on 100 parts by mass of linear thermally curable resin. If the blended amount of such amorphous silica fine particles having through-pores is less than 0.1 parts by mass, the effect by addition of silica fine particles is low, and if the blended amount is greater than 80 parts by mass, it is difficult to increase a factor of filling in the through-pores and it is thus difficult to obtain desired properties.

The thermally curable resin composition of the embodiment of the present invention may be cured under heating to obtain a cured product thereof. In the cured product, the resin composition containing a cured linear thermally curable resin communicates with the through-pores of amorphous silica fine particles.

In the resin composition of the embodiment of the present invention and the cured product thereof, the resin composition containing the linear thermally curable resin preferably communicates with 75 to 100% of through-pores of silica fine particles. Moreover, such a resin composition more preferably communicates with 90 to 100% of such through-pores.

In the resin composition of the embodiment of the present invention and the cured product thereof, whether the resin composition containing the linear thermally curable resin communicates with through-pores of amorphous silica fine particles can be checked by a publicly known method. This can be checked by, for example, a method in which the specific gravity of the cured product of the thermally curable resin composition obtained is measured to determine a volume factor (%) of filling in the through-pores, or observation of the cured product with a transmission electron microscope.

### EXAMPLES

### 1. Preparation of Thermally Curable Resin Composition

In the following examples 1 to 3, a slurry of honeycomb mesoporous silica fine particles having a honeycomb structure (PC-200G-MCA manufactured by Admatechs; effective amount of silica: 15% by weight; main solvent: methylethylketone) was used as amorphous silica fine particles having through-pores. A “slurry of spherical porous silica fine particles” was used in comparative example 1, and a “slurry of spherical silica fine particles” was used in comparative example 2. Furthermore, they were produced by the following methods.

Production of “Slurry of Spherical Porous Silica Fine Particles”

Spherical porous silica fine particles (Sunsphere H-31 manufactured by AGC S.I. Tech, Inc.) were used as a filler and methylethylketone was used as an organic solvent to prepare a slurry matter. First, 40 parts by weight of methylethylketone and 3 parts by weight of silane coupling agent (KBM-403 manufactured by Shin-Etsu Silicones Co., Ltd.: 3-glycidoxypropyltrimethoxysilane) as a dispersion adjuvant were preliminarily stirred, and to the resultant mixture were added 100 parts by weight of spherical porous silica fine particles, followed by preliminarily stirring the resultant mixture again by a stirrer. Then, the mixture was dispersed using a bead mill to produce a uniformly dispersed slurry having 70% by weight of effective silica.

Production of “Slurry of Spherical Silica Fine Particles”

A “slurry of spherical silica fine particles” having 70% by weight of effective silica was obtained in accordance with a procedure similar to the method for producing a “slurry of spherical porous silica fine particles”, except that spherical silica fine particles (Admafine SO-E2 manufactured by Admatechs) were used as a filler.

### Example 1

A solid epoxy resin (bisphenol A epoxy resin iER 1001 manufactured by Japan Epoxy Resins Co., Ltd.) and a liquid epoxy resin (bisphenol A epoxy resin jER 828 manufactured by Japan Epoxy Resins Co., Ltd.) as linear thermally curable resins, 2-ethyl-4-methylimidazole (2E4MZ manufactured by Shikoku Chemicals Corporation) as an epoxy resin curing agent, a slurry of honeycomb mesoporous silica fine particles (PC-200G-MCA manufactured by Admatechs; amount of effective silica: 15% by weight) as a slurry of silica fine particles, an acrylic antifoam leveling agent as an additive and diethyleneglycolmonomethylether acetate as a diluent solvent were weighed into a round bottom flask at the blended ratio shown in Table 1.

Then, the resultant mixture was sufficiently stirred using an auto-revolution stirrer, and thereafter methylethylketone in the slurry was sufficiently volatilized using a rotary evaporator to obtain a thermally curable resin composition “with a thermally curable resin filled in honeycomb mesoporous silica fine particles”

### Example 2

A thermally curable resin composition was obtained in a manner similar to that of example 1, except that the blended ratio of the slurry of honeycomb mesoporous silica fine particles was changed from 267 parts by mass to 133 parts by mass.

### Example 3

A thermally curable resin composition was obtained in a manner similar to that of example 1, except that only a solid epoxy resin was blended as an epoxy resin.

### Example 4

In example 4, a thermally curable resin composition was prepared in a manner similar to that of example 1, except that a linear thermally curable resin was used in combination with other thermally curable resin (dicyclopentadiene epoxy resin).

### Example 5

In example 5, a thermally curable resin composition was prepared in a manner similar to that of example 1, except that spherical silica fine particles were further added as a filler.

### Comparative Example 1

A thermally curable resin composition was obtained in a manner similar to that of example 1, except that a slurry of spherical porous silica fine particles was used in place of a slurry of honeycomb mesoporous silica fine particles. In this connection, the blended amount of the slurry of spherical porous silica fine particles was combined with the parts by mass of effective silica of example 1.

### Comparative Example 2

A thermally curable resin composition was obtained in a manner similar to that of example 1, except that a slurry of spherical silica fine particles was used in place of a slurry of honeycomb mesoporous silica fine particles. In this connection, the blended amount of the slurry of spherical silica fine particles was combined with the parts by mass of effective silica of example 1.

### Comparative Example 3

A thermally curable resin composition was obtained in a manner similar to that of example 1, except that a slurry of honeycomb mesoporous silica fine particles was not added.

### Comparative Example 4

A thermally curable resin composition was obtained in a manner similar to that of example 1, except that a dicyclopentadiene epoxy resin (nonlinear thermally curable resin) was used in place of a bisphenol A epoxy resin (linear thermally curable resin).

### Comparative Example 5

A thermally curable resin composition was obtained in a manner similar to that of example 1, except that a dicyclopentadiene epoxy resin (nonlinear thermally curable resin) was used in place of a bisphenol A epoxy resin (linear thermally curable resin), and a slurry of honeycomb mesoporous silica fine particles was not added.

TABLE 1

| | Example | Example | Example | Example | Example | Comparative | Comparative | Comparative | Comparative | Comparative |
|---|---|---|---|---|---|---|---|---|---|---|
| | 1 | 2 | 3 | 4 | 5 | Example 1 | Example 2 | Example 3 | Example 4 | Example 5 |
| Thermally curable | | | | | | | | | | |
| resin | | | | | | | | | | |
| jER828 | 50 | 50 | | 50 | 50 | 50 | 50 | 50 | | |
| jER1001 | 50 | 50 | 100 | | 50 | 50 | 50 | 50 | | |
| HP-7200 | | | | 50 | | | | | 100 | 100 |
| Slurry of silica | | | | | | | | | | |
| fine particles | | | | | | | | | | |
| Honeycomb | 40 | 20 | 40 | 20 | 30 | | | | 40 | |
| mesoporous | | | | | | | | | | |
| silica | | | | | | | | | | |
| Spherical Porous | | | | | | 40 | | | | |
| silica | | | | | | | | | | |
| Spherical silica | | | | | 10 | | 40 | | | |
| Epoxy curing | | | | | | | | | | |
| agent | | | | | | | | | | |
| 2E4MZ | 4 | 4 | 4 | 4 | 4 | 4 | 4 | 4 | 4 | 4 |
| Diluent | | | | | | | | | | |
| solvsolvent | | | | | | | | | | |
| Diethylene glycol | 70 | 70 | 70 | 70 | 70 | 70 | 70 | 70 | 70 | 70 |
| monoethyl ether | | | | | | | | | | |
| acetate | | | | | | | | | | |
| Additive | | | | | | | | | | |
| BYK-361N | 3 | 3 | 3 | 3 | 3 | 3 | 3 | 3 | 3 | 3 |

In Table 1, the blended amounts of components in the composition are shown in parts by mass with the blended amount of thermally curable resin being 100 parts by mass. The names of the components described in Table 1 and their sources are as follows.

jER 828: liquid bisphenol A epoxy resin (manufactured by Japan Epoxy Resins Co., Ltd.)

jER 1001: solid bisphenol A epoxy resin (manufactured by Japan Epoxy Resins Co., Ltd.)

HP-7200: dicyclopentadiene epoxy resin (manufactured by DIC Corporation)

2E4MZ: 2-ethyl-4-methylimidazole (manufactured by Shikoku Chemicals Corporation)

BYK-361N: acrylic antifoam leveling agent (manufactured by Bigchemi Japan Co., Ltd.)

2. Evaluation

### (Preparation of Samples for Property Measurement)

The obtained thermally curable resin compositions of examples 1 to 5 and comparative examples 1 to 5 were coated on glossy surfaces of copper foils having a thickness of 18 pm using a bar coater, dried in a circulating hot air oven at 90° C. for 20 minutes, and then cured at 170° C. for 60 minutes. These copper foils were then stripped off to obtain film samples for property measurement having a thickness of 50±3 μm.

### (Measurement of Coefficient of Linear Expansion)

The obtained samples for property measurement were measured for their coefficients of linear expansion using an apparatus thermomechanical analysis (TMA-120 manufactured by Seiko Instruments Inc.). The rate of temperature rise for measurement was 5° C./minute. The pre-Tg linear expansion coefficients (α1) of these samples were determined at a temperature range of 40° C. to 60° C.

### (Measurement of Elastic Modulus, Breaking Strength and Elongation)

The obtained samples for property measurement were measured for their elastic moduli and elongations using a tensile tester (Autograph AGS-100N manufactured by Shimadzu Corporation). For measurement conditions, the sample width was about 10 mm, the distance between points of support was about 40 mm, the tension speed was 1.0 mm/minute, the strength at breaking was taken as the breaking strength, and the elongation at breaking was taken as the elongation.

Measurement results for the coefficients of linear expansion, elastic moduli, breaking strengths and elongations are shown Table 2 below.

TABLE 2

| | Example | Example | Example | Example | Example | Comparative | Comparative | Comparative | Comparative | Comparative |
|---|---|---|---|---|---|---|---|---|---|---|
| | 1 | 2 | 3 | 4 | 5 | Example 1 | Example 2 | Example 3 | Example 4 | Example 5 |
| Coefficient | | | | | | | | | | |
| of linear | | | | | | | | | | |
| expansion | | | | | | | | | | |
| α 1 (pre-Tg) | 54 | 62 | 47 | 56 | 57 | 60 | 62 | 82 | 56 | 70 |
| ppm | | | | | | | | | | |
| Elastic | | | | | | | | | | |
| modulus | | | | | | | | | | |
| MPa | 3394 | 2466 | 3435 | 2578 | 2850 | 2909 | 2476 | 1909 | 3687 | 1991 |
| Breaking | | | | | | | | | | |
| strength | | | | | | | | | | |
| MPa | 92.1 | 81.0 | 79.2 | 76.6 | 82.0 | 72.2 | 69.0 | 70.3 | 6.9 | 49.0 |
| Elongation | | | | | | | | | | |
| % | 6.5 | 7.4 | 5.2 | 6.3 | 7.0 | 4.5 | 7.4 | 9.7 | 0.2 | 3.1 |

As shown in Table 2, the compositions of comparative example 1 containing spherical porous silica and comparative 2 containing spherical silica have low coefficients of linear expansion, but do not have improved breaking strengths, as compared to comparative example 3 (having a composition same as those of comparative examples 1 and 2 except that silica fine particles are not contained).

On the other hand, the compositions of examples 1 and 2 containing mesoporous silica fine particles having a honeycomb structure have low coefficients of linear expansion, high breaking strengths, high elastic moduli and insignificant elongation losses, as compared to comparative example 3 (having a composition same as those of examples 1 and 2 except that such silica fine particles are not contained).

Furthermore, the composition of example 3 represents an example of the embodiment of the present invention in which only a solid epoxy resin is used as a linear thermally curable resin. Like the compositions of examples 1 and 2, the composition of example 3 has a low coefficient of linear expansion, a high breaking strength, a high elastic modulus and an insignificant elongation loss, as compared to comparative example 3.

Further, the composition of example 4 represents an example of the embodiment of the present invention in which a linear thermally curable resin is used in combination with a dicyclopentadiene epoxy resin, and the composition of example 5 represents an example of the embodiment of the present invention in which spherical silica fine particles are further added as a filler. The compositions of examples 4 and 5 also have low coefficients of linear expansion, high breaking strengths, high elastic moduli and insignificant elongation losses, as compared to comparative example 3.

Comparative examples 4 and 5 represent an example in which a dicyclopentadiene epoxy resin which is not a linear epoxy resin is used as a thermally curable resin. The composition of comparative example 5 which does not contain silica fine particles has a high coefficient of linear expansion and a low breaking strength and elongation. Furthermore, if mesoporous silica fine particles having a honeycomb structure is incorporated into the composition (as in the composition of comparative example 4), the coefficient of linear expansion decreases, but the breaking strength and elongation significantly decrease, as compared to the composition of comparative example 5.

According to the thermally curable resin composition of the embodiment of the present invention, the linear thermally curable resin is caused to communicate with through-pores of amorphous silica fine particles, whereby the coefficient of linear expansion of the thermally curable resin composition can be reduced and the mechanical strength of the thermally curable resin composition can be improved without significantly impairing the extensibility of the curable resin itself.

Obviously, numerous modifications and variations of the present invention are possible in light of the above teachings. It is therefore to be understood that within the scope of the appended claims, the invention may be practiced otherwise than as specifically described herein.

What is claimed is:

1. A thermally curable resin composition comprising:
a linear thermally curable resin; and
amorphous silica fine particles having pore portions.

2. The thermally curable resin composition according to claim 1, wherein the linear thermally curable resin comprises
at least one of a linear epoxy resin and linear episulfide resin.

3. The thermally curable resin composition according to claim 1, wherein the linear thermally curable resin comprises
a mixture comprising:
at least one of a linear epoxy resin and linear episulfide resin; and
a tri- or more functional nonlinear epoxy resin.

4. The thermally curable resin composition according to claim 1, wherein the amorphous silica fine particles comprise silica fine particles having a honeycomb structure.

5. The thermally curable resin composition according to claim 1, wherein the amorphous silica fine particles have a pore diameter of about 1 nm to about 10 nm and an average particle size of about 0.01 to about 10 μm.

6. A cured product of a thermally curable resin composition, the thermally curable resin composition comprising:
a linear thermally curable resin; and
amorphous silica fine particles having pore portions, the linear thermally curable resin curing to be a cured resin, which communicates with the pore portions of the amorphous silica fine particles.

7. A cured product of a thermally curable resin composition, the thermally curable resin composition comprising:
a linear thermally curable resin composition; and
amorphous silica fine particles having a honeycomb structure.

8. The thermally curable resin composition according to claim 2, wherein the amorphous silica fine particles have a pore diameter of about 1 nm to about 10 nm and an average particle size of about 0.01 to about 10 μm.

9. The thermally curable resin composition according to claim 3, wherein the amorphous silica fine particles have a pore diameter of about 1 nm to about 10 nm and an average particle size of about 0.01 to about 10 μm.

10. The thermally curable resin composition according to claim 4, wherein the amorphous silica fine particles have a pore diameter of about 1 nm to about 10 nm and an average particle size of about 0.01 to about 10 μm.

11. The cured product according to claim 6, wherein the linear thermally curable resin comprises
at least one of a linear epoxy resin and linear episulfide resin.

12. The cured product according to claim 6, wherein the linear thermally curable resin comprises
a mixture comprising:
at least one of a linear epoxy resin and linear episulfide resin; and
a tri- or more functional nonlinear epoxy resin.

13. The cured product according to claim 6, wherein the amorphous silica fine particles comprise silica fine particles having a honeycomb structure.

14. The cured product according to claim 6, wherein the amorphous silica fine particles have a pore diameter of about 1 nm to about 10 nm and an average particle size of about 0.01 to about 10 μm.

15. The cured product according to claim 11, wherein the amorphous silica fine particles have a pore diameter of about 1 nm to about 10 nm and an average particle size of about 0.01 to about 10 μm.

16. The cured product according to claim 12, wherein the amorphous silica fine particles have a pore diameter of about 1 nm to about 10 nm and an average particle size of about 0.01 to about 10 μm.

17. The cured product according to claim 13, wherein the amorphous silica fine particles have a pore diameter of about 1 nm to about 10 nm and an average particle size of about 0.01 to about 10 μm.
